(19) United States
(12) Patent Application Publication
(10) Pub. No.: US 2020/0328909 A1
(43) Pub. Date: Oct. 15, 2020

(54) ALERT GENERATION TRIGGERED BY POWER PORT DETACHMENT

(71) Applicants: Russell M. HANABUSA, Santa Clara, CA (US); Jennie K. Hanabusa, Santa Clara, CA (US)

(72) Inventors: Russell M. HANABUSA, Santa Clara, CA (US); Jennie K. Hanabusa, Santa Clara, CA (US)

(21) Appl. No.: 16/861,088

(22) Filed: Apr. 28, 2020

Related U.S. Application Data
(63) Continuation-in-part of application No. 15/789,835, filed on Oct. 20, 2017, now Pat. No. 10,637,995.
(60) Provisional application No. 62/507,797, filed on May 18, 2017.

(51) Int. Cl. H04L 12/18

(52) U.S. Cl. CPC H04L 12/1895; H04W 88/02

(57) ABSTRACT

A method and apparatus for automatic alert generation is presented. The apparatus includes a wireless communications device having a processor, a memory, a location determination chip, a camera, a microphone, a wireless communications circuitry, and a power port, and a connector having a first portion that detachably couples to the power port. and a second portion that attaches to a person or a power source. The wireless communications device automatically generates and transmits an alert upon sensing a detachment of the connector from the power port. The connector may be a power cord, in which case detachment may be sensed based on change in charge status. The connector may be an accessory, such as ear buds, in which case detachment may be sensed based on the position of a mechanical piece in the power port. A recording of the surrounding area immediately prior to the detachment is included in the alert.

### CROSS-REFERENCE TO RELATED APPLICATION

This application is a Continuation-in-Part of U.S. patent application Ser. No. 15/789,835 filed on Oct. 20, 2017, now U.S. Pat. No. 10,637,995, the content of which is incorporated by reference herein in its entirety.

### RELATED FIELD

This disclosure relates generally to a method and apparatus for triggering a transmission and more specifically to a method and apparatus for triggering an alert transmission by a wireless communications device.

### BACKGROUND

Crimes such as kidnapping, assault, and rape have been a problem for many years all over the world. To avoid being caught, criminals who commit these crimes usually launch their attacks in areas that are deserted or dark, or act fast enough that even if they are seen snatching or assaulting someone, there is not enough time for a bystander to take any action. As a result, it often takes a long time—hours, days, or sometimes weeks—for someone to even realize that a crime has been committed. A long time gap between the initial attack and the realization that a crime has occurred makes it difficult to catch the criminals, and contributes to the continual commitment of these crimes by allowing more criminals to go unpunished.

In theory, modern technology such as mobile phones should make it easy for victims to notify others that a crime has occurred. For example, the victim could quickly take a photo of the attacker and send it to a family member or a friend, along with location information and a message like “Help!” However, in practice, this is unlikely because the criminals are usually smart enough to take away the victim's access to his/her phone. In fact, many phones get accidentally dropped or intentionally left behind during attacks. Furthermore, as the assault or attack is usually a surprise, it is unlikely that the victim will be able to think of using his/her phone to notify others that the attack is happening before the criminal takes the phone away.

Incidents that could benefit from prompt notification to others are not limited to crimes or assaults on a person. Drivers may hit another vehicle and drive away, or try to lie about what happened to avoid liability. While dash cameras offer ability to record and store footages, the recordings are not helpful if the dash camera itself gets damaged. Furthermore, if there is any injury involved in the accident, it takes time for proper family members to get notified.

A system and method of communicating the occurrence of a crime or accident in a fast and reliable manner is desired.

### SUMMARY

In one aspect, the disclosure pertains to an apparatus for automatically generating an alert based on a triggering event. The apparatus includes a wireless communications device having a processor, a memory, a location determination chip, a camera, a microphone, a wireless communications circuitry, and a power port, and a connector having a first portion that detachably couples to the power port, and a second portion that attaches to either a person or a power source, wherein the wireless communications device automatically generates and transmits an alert upon sensing a detachment of the connector from the power port.

In another aspect, the disclosure pertains to a computer-implemented method of automatically generating an alert. The method includes receiving an activation command via a wireless communications device that has a power port, confirming that a connector is connected to the power port, monitoring charge status based on power supply through the power port, and automatically generating and transmitting an alert in response to a change in charge status from charging to not charging.

In yet another aspect, the disclosure pertains to a computer-implemented method of automatically generating an alert. The method entails receiving an activation command via a wireless communications device that has a power port and a movable mechanical piece in the power port, confirming that a connector is connected to the power port, and automatically generating an alert based on change in position of the movable mechanical piece.

### DESCRIPTION OF THE DRAWINGS

FIG. 1 depicts an alert generation apparatus 10 in accordance with one embodiment of the inventive concept.

FIG. 2 depicts a wireless communications device.

FIG. 3 depicts the connector coupled to the wireless communications device 20 and the power source.

FIG. 4 depicts a situation where the connector is unintentionally detached from the wireless communications device, as depicted by an arrow indicating the direction of a force.

FIG. 5 depicts the situation where the connector gets decoupled from the power source.

FIG. 6 is a flowchart depicting the automatic alert generation process executed by the wireless communications device.

FIG. 7 illustrates that the alert generation is triggered by a change in charge status rather than physical decoupling.

FIG. 8 depicts an example embodiment of the apparatus in accordance the inventive concept.

### DETAILED DESCRIPTION

This disclosure provides an apparatus and method for sending alerts about a crime or accident almost in real time, along with information that will help catch the perpetrator. Notably, this instant alert system does not necessarily require any deliberate action from the victim to generate an alert. The inventive concept makes it easier to catch the perpetrator, therefore acting as a deterrent for crimes or lies regarding an accident.

The alert apparatus according to the inventive concept has two parts: a wireless communications device such as a mobile phone, and a connector that attaches to a power port of the portable wireless communications device. In one embodiment, the connector is a power cord that supplies power to the portable wireless communications device. For example, the connector may be have a first end configured to plug into a power port that supplies power to the wireless communications device, and a second end configured to couple to a power source. The power source may be an electrical outlet, battery, a USB port, a 12V socket in a vehicle, or any other conventional power source. The connector may be plugged into an adapter that plugs into the power port of the wireless communications device.

Where the connector is a power cord, a first end of the connector will couple to the power port of the wireless communications device, and a second end of the connector will couple to a power source. When an attack or an accident happens, a sudden motion or a jerk causes the connector to detach from either the wireless communications device or the power source. This detachment of the connector from the power port is a triggering event, as the wireless communications device detects the change in charge status and transmits one or more alerts. The alerts may include message(s) and/or phone call(s) to certain phone number(s) and email(s), as preset by the user.

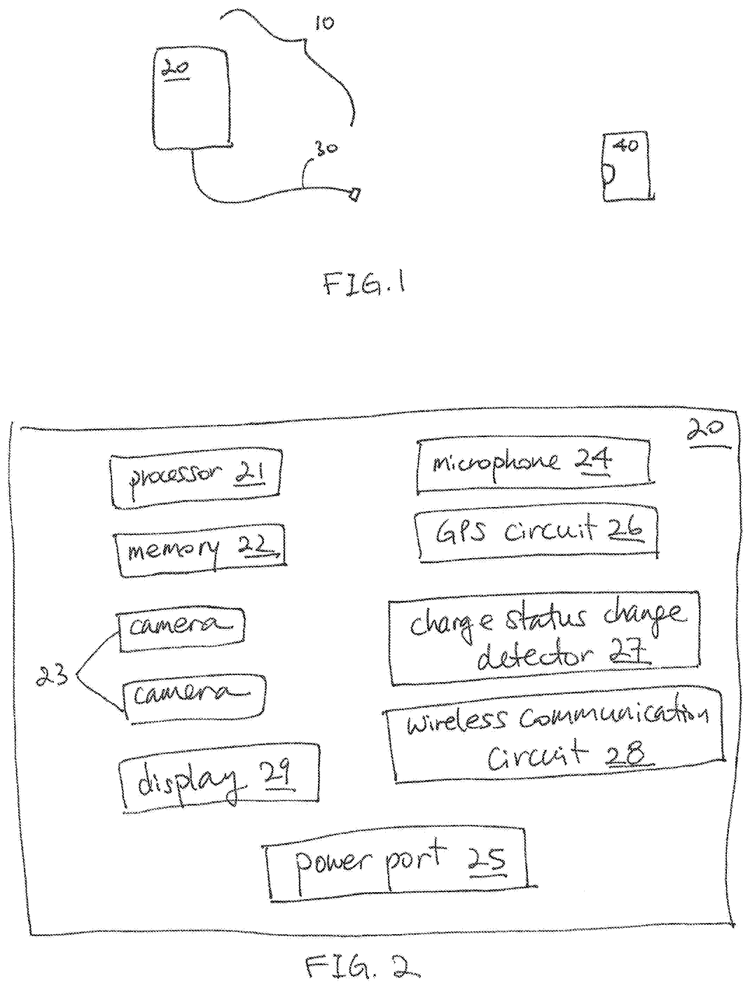

FIG. 1 depicts an alert generation apparatus 10 in accordance with one embodiment of the inventive concept. As shown, the alert generation apparatus 10 includes a wireless communications device 20 that may be carried by a person and/or attached to an object such as a vehicle, a bag, etc., and a connector 30 that detachably connects to the wireless communications device 20.

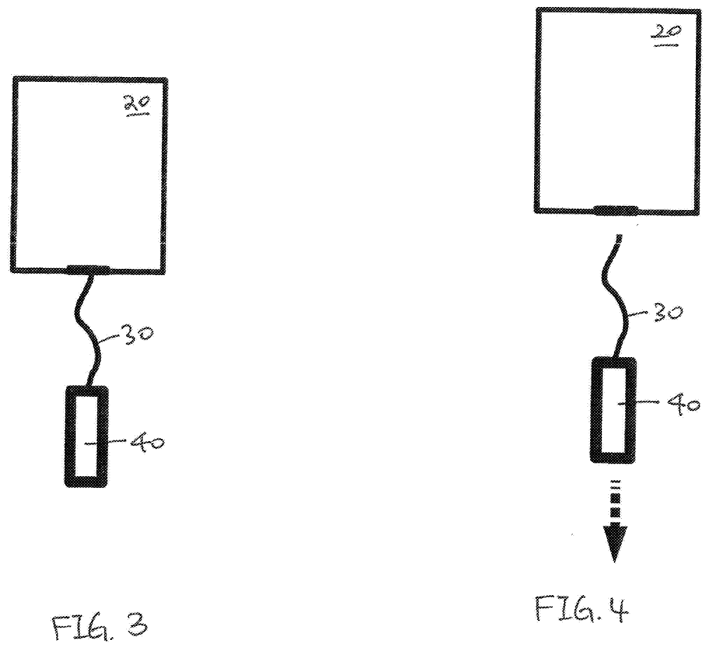

FIG. 2 depicts the wireless communications device 20 in more detail. As shown, the wireless communications device 20 has a processor 21 and a memory 22, one or more cameras 23 and a microphone 24 that enable it to record images and sounds, a GPS circuit 26 to determine the device's location, a charge status change detector 27, a wireless communications circuitry 28, and a power port 25. The charge status change detector 27 may be circuitry that detects when the charge flow suddenly stops. In some embodiments, the charge status change detector 27 may detect change in charge flow availability, so that the change in status can be detected even if the device 20 is already 100% charge. Some embodiments of the wireless communications device 20 may have a display 29. It should be understood that the GPS circuit 26 may be substituted by any other known methods of determining geographic location. The wireless communication device 20 will have other parts that are not explicitly shown in FIG. 2.

The wireless communications device 20 may be, but does not have to be, a mobile phone (e.g., a smart phone), a personal digital assistant (PDA), a laptop computer, or a tablet, among other devices. The connector 30 may be a power cord that is configured to plug into the power port 25 either directly or indirectly. The other end of the connector 30 is configured to couple to a power source. “Indirect coupling” into the power port, as used herein, means there is one or more pieces between the power port and the connector, such as an adapter. The adapter may have a portion that plugs into the power port and another portion that couples with the connector 30. “Direct coupling” into the power port means one end of the connector 30 is configured to plug into the power port 25 without an intervening piece.

While a first end of the connector 30 is configured to attach, directly or indirectly, to the wireless communications device 20, a second end of the connector 30 is configured to couple with a power source 40. The power source 40 may be an electrical outlet, a battery, a USB port, port of another mobile device, a power port of a vehicle (e.g., a motorcycle, automobile, electric bicycle). The power source 40 does not include the internal battery of the wireless communications device 20.

FIG. 3 depicts the connector 30 coupled to the wireless communications device 20 and the power source 40. In this state, charge is available to flow into the wireless communications device 20. In this state, the user may activate the charge-status-change-based triggering program on the device 20, for example by using the interactive display 29. In some embodiments, even with the charge-status-change-based triggering program activated, a user may detach the connector 30 from the wireless communications device 20 without triggering an alert by taking a small, easy detachment step. The detachment step may include, for example, pushing or sliding aside a small button or mechanical piece, moving the coupling mechanism on the connector 30 in a certain way, or using the interactive display 29 to indicate the desire to detach the connector 30.

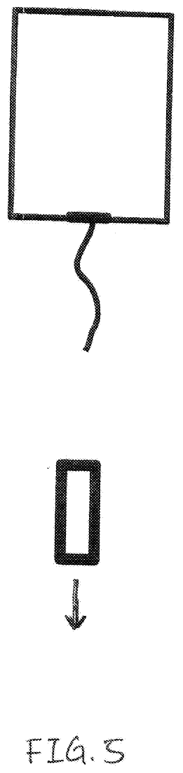

FIG. 4 depicts a situation where the connector 30 is unintentionally detached from the wireless communications device 20, as depicted by an arrow indicating the direction of a force. Immediately upon detachment, the charge status change detector 27 detects that there is no charge flowing into the circuit, and the processor 21 generates an alert and transmits it automatically in a predefined manner.

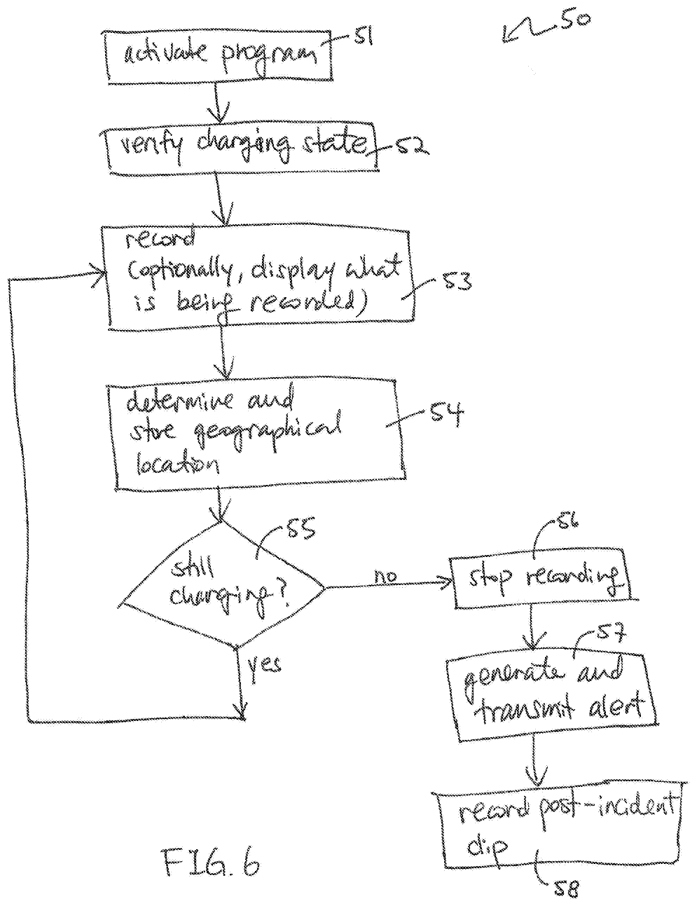

FIG. 5 depicts the situation where the connector 30 gets decoupled from the power source 40. Even if the connector 30 remains attached to wireless communications device 20, the decoupling of the power source 40 causes a stop in charge flow, triggering alert generation.

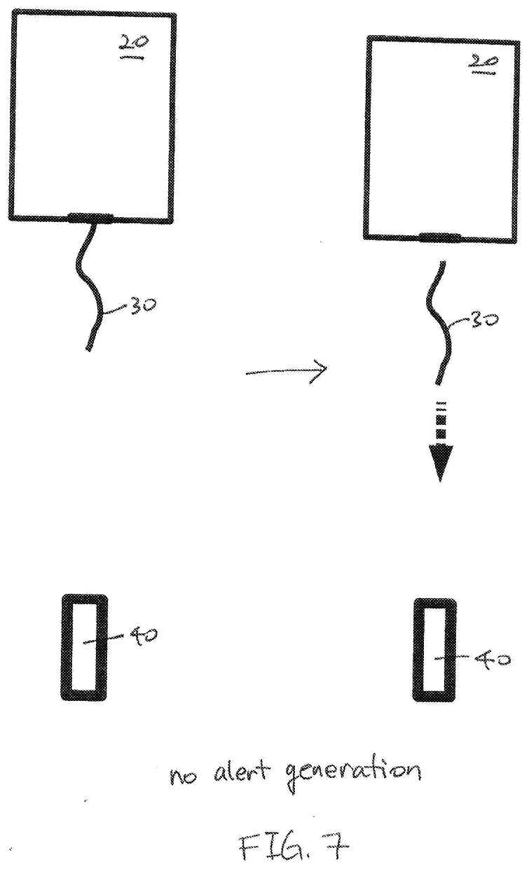

FIG. 6 is a flowchart depicting the automatic alert generation process 50 executed by the wireless communications device 20. As shown, the process 50 is composed of a loop. The automatic alert generation process 50 includes the following sub-processes:
Activate program (51). This is done in response to user input, for example using the interactive display 29.
Verify that charge flow is happening or available to happen (52). This ensures that the connector 30 is attached properly to both the wireless communications device 20 and the power source 40.
Record short video clips and optionally, display what is being recorded on the display 29 (53). The recording(s) could be made using multiple cameras of a wireless communications device 20. For example, the front and back cameras of a mobile phone could simultaneous be used to record a picture-in-picture video recording.
Determine and store geographical location (54).
Check if there is a change in status from “charging” to “not charging” (55).
If a stop in charge status is detected in step 55 and there was no deliberate disengaging, stop recording immediately (sub-process 56).
Immediately transmit an alert with the recording (and optionally, the location) to prestored number(s) and email address(es). The recording may be of the last x seconds (e.g., 10 seconds) right up to the moment of the triggering event. Alert may also include turning on speaker phone and calling predefined phone number(s) (sub-process 57).
Record post-incident video for a preset time duration (sub-process 58).
If there is no triggering event detected in sub-process 55, repeat the loop.

The wireless communications device 20 records videos of its surroundings (in steps 53 and 58) using the camera(s) 23 and microphone 24. The video recordings may include images and sounds, and short video clips of a predefined length (for example 10 seconds). The loop in the automatic alert generation process 50 may repeat at a preselected time interval. If the loop is set to repeat every 0.1 seconds, it will be checked every 0.1 seconds whether a triggering event has been detected because sub-process 56 will happen every 0.1 seconds. The video clip that is recorded in sub-process 42 may be longer than the interval at which the loop repeats—for example, the video clip may be 10 seconds long. In this case, the recording that is maintained will be a clip of the most recent full 10 seconds video recording, which will be updated to the “new” most recent 10 seconds every time the loop repeats. A “triggering event,” as used herein, is a change in the charging status.

The stored short video clips are continuously updated as the automatic alert generation process 50 repeats the loop, so that there will always be a video of the time just before a triggering event that is available for immediate transmission upon the triggering event. When it is detected in step 55 that the device 20 has stopped charging, the current video recording in progress is immediately stopped and saved. This video file is immediately transmitted as part of the alert in sub-process 57. Optionally, the geographic location or other pre-trigger video files could also be transmitted with the alert. This stopping of recording and immediate transmission assures that at least 10 seconds of pre-trigger video up to the triggering event is transmitted as quickly as possible. The post-trigger video will be 10 seconds long. Likewise, the geographical location of the phone is updated and available for immediate transmission upon a triggering event. “Immediate,” as used herein, means in less than a few seconds, and in some cases in less than one second, of the triggering event happening.

The method of automatic alert generation process 50 minimizes the use of expensive wireless data transmissions by locally recording and storing pre-trigger event video and only transmitting these short recordings in response to a triggering event. This eliminates the need and expense of continuously transmitting video wirelessly to transmit the few seconds just prior to the triggering event.

Optionally, the video that is being recorded may be displayed on the display of the wireless communications device 20. The wireless communications device 20 also determines its geographic location in step 54, for example by using the GPS circuitry or calculating location using the position of cell phone towers. If a triggering event is detected in step 55, the recording and the GPS coordinates are automatically and immediately transmitted to predesignated number(s) and email(s) in step 57. After the triggering event is detected, more video is recorded and transmitted, the speaker phone is turned on, and phone call(s) are made to predesignated number(s). These predesignated numbers may be the phone number(s) of a family member, a friend, or a law enforcement unit. The automatic alert generation process 50 may repeat in a loop as long as the wireless communications device 20 has charge.

In some embodiments, the video recording may continue in step 58 after the alert is generated in sub-process 57. This post-trigger recording may be limited to a preset length, for example 15 seconds. The post-trigger recording may provide additional information that is helpful for catching the criminal or determining what happened at the crime scene.

Generating the alert in step 57 may include various steps, such as sending text message(s) and email(s) which include the victim's phone/device location, transmitting pre-trigger video clip(s) and/or picture(s), making new post-trigger video clip(s) and transmitting them (sub-process 49), making phone calls to predefined number(s), and turning on the speaker phone.

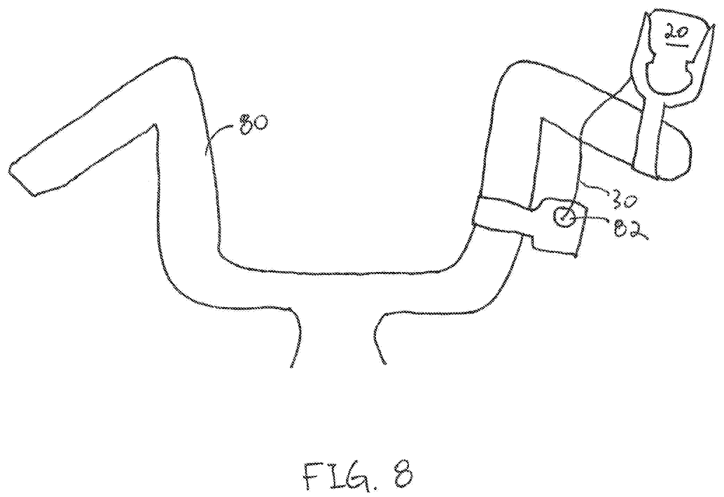

FIG. 7 illustrates that the alert generation is triggered by a change in charge status rather than physical decoupling. In other words, if there is no charge flowing into the wireless communications device 20 to begin with (i.e., at activation of the program), because the connector 30 is attached to the device 20 but not the power source 40, the detachment of the connector 30 from the wireless communications device 20 will not trigger an alert because there is no change in charge status. Detaching an unpowered power cord does not trigger an alert.

In the charge-status-change-based triggering, either a physical separation of the connector 30 from the wireless communications device 20 or a physical separation of the connector 30 from the power source 40 causes the alert to be transmitted. Where there is an adapter (not shown) between the connector and the wireless communications device 20, either the detachment of the connector 30 from the adapter or the detachment of the adapter from the power port 28 of the wireless communications device 20 may trigger the alert generation.

FIG. 8 depicts an example embodiment of the apparatus in accordance the inventive concept. In this particular example, the wireless communication device 20 is attached to the handlebar 80 of a motorcycle, with the connector 30 plugged into a power socket 82. The connector 30 may also be connected into a USB port of the motorcycle (not shown). The wireless communication device 20 is positioned such that it can view and record what is happening in front of and/or behind the motorcycle, perhaps using a front camera and a back camera. Alternatively, in some cases, the rider may attach the wireless communication device 20 on a backpack that he wears during the ride, so that the wireless communication device 20 can record what is happening behind the motorcycle. The connector 30 is attached to the wireless communication device 20 in such a manner that if there is an impact, it becomes detached from the device 20. Alternatively, upon impact, the connector 30 may get detached from the power socket 82. The recording of what happened for a preset period before the impact gets transmitted to one or more preselected email addresses or phone numbers automatically and immediately upon impact, with minimal lag time. If the wireless communication device 20 is not damaged, the post-triggering-event recording starts, and records what happens post impact. The recordings should be helpful in determining fault for insurance claims or in law suits.

In some embodiments, the connector 30 is not a power supply cord but an accessory, such as ear buds that are configured to plug into the power port of the wireless communications device 20. In this case, the first end of the connector is coupled to the wireless communications device 20 and the second end of the connector (the ear buds) is coupled to the person. When there is an attack, fall, or impact that causes the connector 30 to detach from the power port, an alert is generated and transmitted. A mechanical or electrical piece in the wireless communications device 20 helps detect whether something is plugged into the power port. For example, there may be a small piece inside the power port that changes its position when something is plugged into the port. Based on the position of this detection piece, the processor 21 knows whether the connector 30 is attached or not. Similarly to the alert generation process 50 of FIG. 6, a user may have to activate the alert generation process 50 after plugging the ear buds into the port, to avoid the alert from being triggered every time the ear buds are disconnected.

The program for the automatic alert generation method can run either visibly on the screen of the Portable Wireless Communications Device or in the background without being visible on the screen. The program would run simultaneously with other programs of the wireless communications device.

It should be understood that the invention can be practiced with modification and alteration within the spirit and scope of the appended claims. The description is not intended to be exhaustive or to limit the inventive concept to the precise form disclosed. It should be understood that the disclosure can be practiced with modifications and alterations.

What is claimed is:

1. An apparatus for automatically generating an alert based on a triggering event, comprising:
a wireless communications device having a processor, a memory, a location determination chip, a camera, a microphone, a wireless communications circuitry, and a power port; and
a connector having a first portion that detachably couples to the power port, and a second portion that attaches to either a person or a power source, wherein the wireless communications device automatically generates and transmits an alert upon sensing a detachment of the connector from the power port.

2. The apparatus of claim 1, wherein the wireless communications device comprises a circuit for detecting charge status and the connector is a power cord, and wherein the circuit detects detachment of the connector based on change in charge status from charging to not charging.

3. The apparatus of claim 2, wherein no alert is transmitted if the charge status is not charging at time of activation.

4. The apparatus of claim 1, wherein the wireless communications device comprises a camera, wherein the alert comprises a recording of the camera's view.

5. The apparatus of claim 1, wherein the wireless communications device comprises a location determining circuit and the alert comprises latest location of the wireless communications device.

6. The apparatus of claim 1 further comprising an adapter between the first portion of the connector and the power port, wherein the wireless communications device automatically generates and transmits the alert in response to either a detachment of the adapter from the power port or a detachment of the connector from the adaptor.

7. The apparatus of claim 1, wherein the wireless communications device comprises a movable mechanical piece inside the power port that changes position when the connector is plugged into the power port, and wherein the alert is generated based on a change in the position of the mechanical piece.

8. The apparatus of claim 1, wherein the alert comprises at least one of an automatic telephone call and/or text message made to a preselected phone number(s) and/or an email message to a preselected email address(es).

9. A computer-implemented method of automatically generating an alert, the method comprising:
receiving an activation command via a wireless communications device that has a power port;
confirming that a connector is connected to the power port;
monitoring charge status based on power supply through the power port; and
automatically generating and transmitting an alert in response to a change in charge status from charging to not charging.

10. The computer-implemented method of claim 9 further comprising creating a recording of images of an area viewable by the wireless communications device, and including the recording with the alert.

11. A computer-implemented method of automatically generating an alert, the method comprising:
receiving an activation command via a wireless communications device that has a power port and a movable mechanical piece in the power port;
confirming that a connector is connected to the power port; and
automatically generating an alert based on change in position of the movable mechanical piece.

12. The computer-implemented method of claim 11 further comprising creating a recording of images of an area viewable by the wireless communications device, and including the recording with the alert.

13. The computer-implemented method of claim 11, wherein the wireless communications device is configured to record images and sounds for a predefined number of seconds in a continuous loop for transmission with the alert.

14. The computer-implemented method of claim 11, wherein transmitting the alert comprises transmitting a latest location information recorded prior to the change in position.

15. The computer-implemented method of claim 11, wherein transmitting the alert comprises of at least one of making a telephone call to a predesignated number(s), sending a text message(s) with recorded video(s) to a predesignated number(s), and sending email(s) to a predesignated email address(es).
